(19) United States
(12) Patent Application Publication
(10) Pub. No.: US 2014/0136871 A1
(43) Pub. Date: May 15, 2014

(54) MOBILE ELECTRONIC DEVICE AND METHOD OF CONTROLLING THE SAME

(71) Applicant: SAMSUNG ELECTRO-MECHANICS CO., LTD., Suwon (KR)

(72) Inventors: Sam Ki JUNG, Suwon, Gyunggi-do (KR); Bo Yle SEO, Suwon, Gyunggi-do (KR); Jong In NA, Suwon, Gyunggi-do (KR)

(73) Assignee: SAMSUNG ELECTRO-MECHANICS CO., LTD., Suwon (KR)

(21) Appl. No.: 14/033,418

(22) Filed: Sep. 20, 2013

(30) Foreign Application Priority Data
Nov. 15, 2012 (KR) 10-2012-0129382

(51) Int. Cl. G06F 1/32

(52) U.S. Cl. CPC G06F 1/3206
USPC 713/323

(57) ABSTRACT

There is provided a mobile electronic device for reducing power consumption, the device including a user input unit receiving a power saving condition; a sensing unit acquiring state information; and a controller changing an operating mode based on the power saving condition and the state information.

### CROSS-REFERENCE TO RELATED APPLICATIONS

This application claims the benefit of Korean Patent Application No. 10-2012-0129382 filed on Nov. 15, 2012, with the Korean Intellectual Property Office, the disclosure of which is incorporated herein by reference.

### BACKGROUND OF THE INVENTION

1. Field of the Invention

The present invention relates to a mobile electronic device having a power saving function and a method of controlling the same.

2. Description of the Related Art

A mobile electronic device is carried by a user and has at least one of voice and video call functions, an information input/output function, a data storing function and the like.

As functions of a mobile electronic device are diversified, it may be implemented as a multimedia player having complicated functions allowing for operations such as taking a picture or a video clip, playing a music or video file, playing a game, receiving a broadcast, and accessing the Internet.

In order to support and expand the functions of a mobile electronic device, improving structural and/or software parts of a terminal may be considered.

Recently, since a mobile electronic device performs various functions, battery consumption is ever-increasing.

In addition, an unintended function may be executed which is unnecessary to a user. Such an execution of an unnecessary function results in a shortened usage time of a mobile electronic device.

To overcome this problem, it is necessary to recognize that an unnecessary function is being executed and to interrupt the unnecessary function.

Patent Document 1 relates to a mobile communications terminal capable of reducing unnecessary power consumption, but does not disclose acquiring a power saving condition and state information of an electronic device to perform a power saving function.

### RELATED ART DOCUMENT

(Patent Document 1) Korean Patent Laid-Open Publication No. 2008-0009877

### SUMMARY OF THE INVENTION

An aspect of the present invention provides a novel approach to reducing power consumption by recognizing and blocking unnecessary functions executed in a mobile electronic device.

According to an aspect of the present invention, there is provided a mobile electronic device for reducing power consumption, the device including: a user input unit receiving a power saving condition; a sensing unit acquiring state information; and a controller changing an operating mode based on the power saving condition and the state information.

The power saving condition may contain gradient information with respect to an axis.

The device may further include a memory to store the power saving condition.

The state information may include at least one of directional information and gradient information.

The controller may determine whether the state information falls within the range of the power saving condition, and, if so, sets an operating mode to a power saving mode.

The controller may determine whether the state information falls within the range of the power saving condition, and, if not, sets an operating mode to a non-power saving mode.

The control unit may determine whether the state information falls within the range of the power saving conditions several times.

According to another aspect of the present invention, there is provided a method of controlling a mobile electronic device, the method including: acquiring a power saving condition; acquiring state information; and changing an operating mode based on the power saving condition and the state information.

The acquiring of the power saving condition may include acquiring gradient information with respect to an axis.

The acquiring of the power saving condition may include changing gradient information with respect to an axis.

The acquiring of the power saving condition may include acquiring the power saving condition stored in a memory base on a user's input.

The acquiring of the state information may include acquiring at least one of directional information and gradient information.

The changing of the operating mode may include: determining whether the state information falls within the range of the power saving condition; and if so, setting an operating mode to a power saving mode.

The changing of the operating mode may include: determining whether the state information falls within the range of the power saving condition; and if not, setting an operating mode to a non-power saving mode.

The changing of the operating mode may include determining whether the state information falls within the range of the power saving conditions several times.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a block diagram showing a mobile electronic device according to an embodiment of the present invention;

FIG. 2 is a flow chart illustrating a method of controlling a mobile electronic device according to an embodiment of the present invention;

FIG. 3 is a diagram showing operation S210 shown in FIG. 2 according to an embodiment;

FIG. 4A to 4F are a diagram showing operation S210 shown in FIG. 2 according to an embodiment;

FIGS. 5A and 5B are a diagram showing operation S210 shown in FIG. 2 according to another embodiment;

FIG. 6 is a diagram showing operation S220 shown in FIG. 2 according to an embodiment; and

FIG. 7 is a diagram showing operation S230 shown in FIG. 2 according to an embodiment.

### DETAILED DESCRIPTION OF THE INVENTION

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

Mobile electronic devices described in the specification may include cellular phones, smartphones, laptop computers, digital broadcasting terminals, personal digital assistants (PDAs), portable multimedia players (PMPs), navigation devices, and the like.

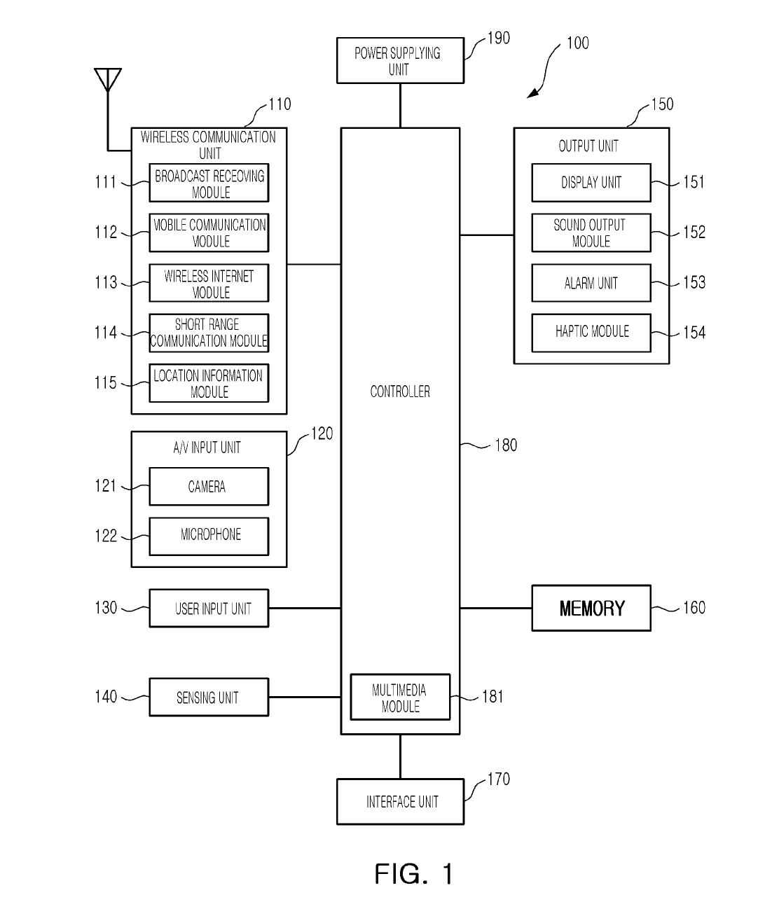

FIG. 1 is a block diagram showing a mobile electronic device according to an embodiment of the present invention.

The mobile electronic device 100 may include a wireless communication unit 110, an audio/video (A/V) input unit 120, a user input unit 130, a sensing unit 140, an output unit 150, a memory 160, an interface unit 170, a controller 180, a power supplying unit 190, and the like. The elements shown in FIG. 1 are not essential elements and, therefore, the electronic device may also be implemented with more or less elements than those shown in FIG. 1.

The wireless communication unit 110 may include at least one module enabling wireless communication between the electronic device 100 and a wireless communication system or between the electronic device 100 and a network in which the electronic device 100 is positioned. For example, the wireless communication unit 110 may include a broadcast receiving module 111, a mobile communication module 112, a wireless Internet module 113, a short range communication module 114, a location information module 115, and the like.

The broadcast receiving module 111 receives a broadcast signal and/or broadcast related information from an external broadcast managing server through a broadcast channel.

The broadcasting channel may include a satellite channel and a terrestrial channel. The broadcast managing server refers to a server that generates and transmits a broadcast signal and/or broadcast related information or a server that receives a previously generated broadcast signal and/or broadcast related information and transmits it to a terminal. The broadcast signal may include a TV broadcast signal, a radio broadcast signal, and a data broadcast signal, as well as a TV broadcasting signal or a radio broadcast signal combined with a data broadcast signal.

The broadcast related information may refer to information related to a broadcast channel, a broadcast program or a broadcast service provider. The broadcast related information may be provided via a mobile communication network. In this case, the information may be received by the mobile communication module 112.

The broadcast related information may be present in various forms. For example, the broadcast related information may be present in a form such as an electronic program guide (EPG) of digital multimedia broadcasting (DMB), an electronic service guide (ESG) for digital video broadcast-handheld (DVB-H), or the like.

The broadcast receiving module 111 may receive digital broadcast signals using a digital broadcasting system such as digital multimedia broadcasting-terrestrial (DMB-T), digital multimedia broadcasting-satellite (DMB-S), media forward link only (MediaFLO), digital video broadcast-handheld (DVB-H), integrated services digital broadcast-terrestrial (ISDB-T), or the like. The broadcast receiving module 111 may be configured to be adequate for broadcasting systems other than the above-mentioned digital broadcasting systems.

The broadcast signal and/or the broadcast related information received through the broadcast receiving module 111 may be stored in the memory 160.

The mobile communication module 112 may transmit/receive wireless signals to/from at least one of a base station, an external terminal, and a server on a mobile communication network. Here, the wireless signal may include various types of data according to a voice call signal, a video call signal, or transmission/reception of a text/multimedia message.

The mobile communication module 112 may be configured to implement a video call mode and a voice call mode. In the video call mode, people talk to each other while seeing their conversation partner via video, whereas in the voice call mode, people talk to each other without seeing their conversation partner via video. In order to implement the video call mode and the voice call mode, the mobile communication module 112 is configured to transmit/receive at least one of voice and video.

The wireless Internet module 113, provided for wireless Internet access, may be embedded in the mobile electronic device 100 or externally provided. The wireless Internet technology usable may include a wireless LAN (WLAN) (Wi-Fi) technology, a wireless broadband (Wibro) technology, a world interoperability for microwave access (Wimax) technology, a high speed downlink packet access (HSDPA) technology, or the like.

The short range communication module 114 refers to a module for short range communication. The short range communication technology may include Bluetooth technology, radio frequency identification (RFID) technology, infrared data association (IrDA) technology, ultra wideband (UWB) technology, ZigBee technology, or the like.

The location information module 115, for acquiring the location of a mobile electronic device, may include a global position system (GPS) module as a representative example.

Referring to FIG. 1, the A/V (audio/video) input unit 120, provided to input an audio signal or a video signal, may include a camera 121, a microphone 122, and the like. The camera 121 processes an image frame such as a still image or a moving image obtained by an image sensor in a video call mode or a photographing mode. The processed image frame may be displayed on a display unit 151.

The image frame processed in the camera 121 may be stored in the memory 160 or may be transmitted to the outside through the wireless communication unit 110. Two or more cameras 121 may be provided depending on the environmental conditions in which the mobile electronic device is used.

The microphone 122 receives external sound signals in a call mode, a sound recording mode, a voice recognition mode, or the like, to process the sound signals to electrical audio data. In the call mode, the processed audio data may be output by being converted into a form in which it may be transmitted to a mobile communication base station through the mobile communication module 112. In the microphone 122, various noise removing algorithms for removing noise generated during a process of receiving an external sound signal may be implemented.

The user input unit 130 may be used for the user to generate input data for controlling an operation of the electronic device. The user input unit 130 may include a keypad, a dome switch, a touch pad (resistive/capacitive), a jog wheel, a jog switch, or the like. Further, the user input unit 130 may be used for selecting an area on a screen displayed on the display unit.

The sensing unit 140 may sense the location of the mobile electronic device 100, the directional information of the mobile electronic device 100, and the gradient information of the mobile electronic device 100. To this end, the sensing unit 140 may include a position sensor, a motion sensor, a gyroscope sensor, an acceleration sensor, a gravity sensor and the like.

The acceleration sensor represents the ratio of increased/decreased speed per hour in a linear direction by a numerical value. The gyroscope sensor may measure an angular velocity. For example, the gyroscope sensor may represent an angle per hour by which an object is rotated with respect to an axis by a numerical value. The gravity sensor may sense and represent a direction in which gravity works using a numerical value.

The directional information may represent a direction in which the front surface of the mobile electronic device 100 is facing. The gradient information may represent the gradient of the mobile electronic device 100 with respect to an axis. For example, assuming the space in which the mobile electronic device 100 is located consists of three axes, i.e., an x-axis, a y-axis and a z-axis, the gradients of the mobile electronic devices 100 with respect to the respective axes, i.e., the x-axis, the y-axis and the z-axis, may be collectively referred to as the gradient information. Further, the axes used for the gradient information may be determined based on the directive information.

Hereinafter, the directional information and the gradient information are collectively referred to as state information of the mobile electronic device 100. Accordingly, the state information may include the gradient of the mobile electronic device 100 with respect to any axis (e.g., x-axis, y-axis and z-axis).

The sensing unit 140 may sense the directional information of the mobile electronics device 100, the gradient information of the mobile electronic device 100 and the like so as to generate a sensing signal for controlling the operation of the mobile electronic device 100.

The output unit 150, provided to generate an output related to visual, auditory, tactile and other information, may include the display unit 151, a sound output module 152, an alarm unit 153, and a haptic module 154.

The display unit 151 may display (output) information processed in the mobile electronic device 100. For example, when the mobile electronic device 100 is in the call mode, the display unit 151 displays a user interface (UI) or a graphic user interface (GUI) related to the call. When the mobile electronic device 100 is in the video call mode or the photographing mode, the display unit 151 displays a photographed and/or received image, a UI or a GUI.

The display unit 151 may include at least one of a liquid crystal display (LCD), a thin film transistor-liquid crystal display (TFT LCD), an organic light-emitting diode (OLED), a flexible display, a three-dimensional (3D) display, and an e-ink display.

Some of these displays may be formed as a transparent type displays or as light transmitting type displays so that the outside may be viewed therethrough. This kind of display may be called a transparent display, a typical example of which includes a transparent OLED (TOLED). The rear structure of the display unit 151 may also be a light transmitting structure. With this structure, a user may be able to see an object located behind the body of a terminal through an area occupied by the display unit 151 of the body of the terminal.

In some implementations, the mobile electronic device 100 may include two or more display units 151. For example, a plurality of display units may be disposed on a surface of the mobile electronic device 100 separately or integrally, or the display units may be disposed on a different surface.

In case that the display unit 151 and a sensor (referred to hereinafter as a touch sensor) sensing a touch operation are formed in a mutual layer structure (referred to hereinafter as a touch screen), the display unit 151 may be used as an input device as well as an output device. That is, the display unit 151 may be used as the user input unit 130. The touch sensor may include a touch film, a touch sheet, a touch pad and the like.

The touch sensor may be configured to convert pressure applied to a point or a change in capacitance of a point on the display unit 151 or the like into an electrical input signal. The touch sensor may not only detect the position and area of a touch but also pressure of the touch.

When a touch is made to the touch sensor, the corresponding signal(s) is transmitted to a touch controller. The touch controller processes the signal (s) and then transmits the corresponding data to the controller 180. By doing so, the controller 180 may identify which area of the display unit 151 has been touched, for example.

The sound output module 152 may output audio data received from the wireless communication unit 110 or stored in the memory unit 160 in a call signal reception mode, a conversation or recording mode, a voice recognition mode, a broadcast reception mode or the like. The sound output module 152 may also output a sound signal (for example, a call signal reception sound, a message reception sound or the like) related to a function performed in the mobile electronic device 100. The sound output module 152 may include a receiver, a speaker, a buzzer and the like.

The alarm unit 153 outputs a signal to notify that an event has occurred in the mobile electronic device 100. Examples of the event occurring in the mobile electronic device include call signal reception, message reception, key signal input, touch, connection with another terminal or the like. The alarm unit 153 may output other forms of signals than video or audio signals, e.g., vibration signals, in order to provide notification that an event has occurred. Since the video or audio signals may be output through the display unit 151 or the sound output module 152, the display unit 151 or the sound output module 152 may be regarded as a part of the alarm unit 153.

The haptic module 154 may generate a variety of tactile effects sensed by a user. A typical tactile effect generated by the haptic module 154 is vibrations. The strength and pattern of the vibrations generated by the haptic module 154 may be controlled. For example, the haptic module may output different vibrations by synthesizing them or sequentially.

The haptic module 154 may generate various types of tactile effects in addition to vibrations, such as a stimulus effect by a pin arrangement vertically moving on contacting skin, a spraying or suction force through a spraying or suction hole, a graze on skin, contact of an electrode, electrostatic force and the like, or a reproduction effect of cold or hot feeling using a device capable of absorbing or generating heat.

The haptic module 154 may not only deliver the tactile effect via direct contact but also use kinesthesia of fingers or arms of a user to deliver the tactile effect. In some aspects, the mobile electronic device 100 may include two or more haptic modules 154.

The memory 160 may store a program for an operation of the controller 180 therein and temporally store input/output data (for example, a phone book, a message, a still image, a moving picture and the like) therein. The memory 160 may store data on various vibrations and sounds output when the touch screen is touched. Further, the memory 160 may store a power saving condition. The memory 160 may include at least one of a flash memory type storage medium, a hard disk type storage medium, a multimedia card micro type storage medium, a card type memory (an SD or XD memory, for example), a random access memory (RAM), a static random access memory (SRMA), a read-only memory (ROM), an electrically erasable programmable read-only memory (EEPROM), a programmable read-only memory (PROM), a magnetic memory, a magnetic disk, and an optical disk. The mobile electronic device 100 may also be operated in association with web storage performing a storing function for the memory 160 on the Internet.

The interface unit 170 serves as a path to all external devices connected to the mobile electronic device 100. The interface unit 170 may receive data or power from external devices so as to transfer the data or power to components in the mobile electronic device 100 or send data inside the electronic device 100 to external devices. The interface unit 170 may include, for example, a wired/wireless headset port, an external charger port, a wired/wireless data port, a memory card port, a port for connecting devices having identity modules, an audio input/output (I/O) port, a video I/O port, an earphone port and the like.

The identity module is a chip that stores various types of information to authenticate the user right of the mobile electronic device 100, and may include a user identify module (UIM), a subscriber identify module (SIM), a universal subscriber identity module USIM and the like. A device having the identity module (referred to hereinafter as an identity device may be manufactured as a type of smart card. Accordingly, the identity device may be connected to the mobile electronic device 100 via a port.

The interface unit 170 may serve as a path via which the power from a cradle is supplied to the mobile electronic device 100 when the mobile electronic device 100 is connected to an external cradle or a path via which various types of command signal from the cradle input by a user is transmitted to the mobile electronic device. The various types of command signal and the power input from the cradle may also serve as a signal indicating that the mobile electronic device has been properly placed in the cradle.

The controller 180 typically controls the general operation of the electronic device. For example, the controller 180 performs controlling and processing associated with a voice call, data communication, a video call and the like. In addition, the controller 180 may generate an operation command corresponding to a touch by a user. In addition, the controller 180 may deactivate some of the functions of the mobile electronic device 100. For example, the controller 180 may control so that supply of power to a component or a module is interrupted.

The controller 180 may also include a multimedia module 181 for reproducing a multimedia content. The multimedia module 181 may be implemented inside the controller 180 or be implemented separately from the controller 180.

In addition, the controller 180 mat change the operating mode of the mobile electronic device 100 based on the power saving condition and the state information.

The operating mode may include a power saving mode and a non-power saving mode.

The non-power saving mode may refer to a normal operating state of the mobile electronic device 100.

In addition, the power saving mode may refer to a state in which some of the functions of the mobile electronic device 100 are deactivated. For example, in the power saving mode, at least one of the wireless communication unit 110, the A/V input unit 120, the user input unit 130 the sensing unit 140, the output unit 150, the memory 160, the interface unit 170, the controller 180 and the power supplying unit 190 may be deactivated. Alternatively, in the power saving mode, at least one of the modules included in the wireless communication unit 110, the A/V input unit 120, the user input unit 130, the sensing unit 140, the output unit 150, the memory 160, the interface unit 170, the controller 180 and the power supplying unit 190 may be deactivated.

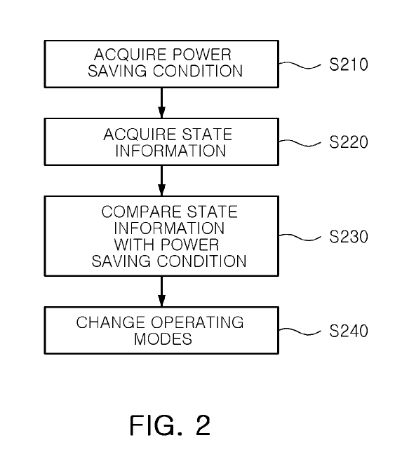

Now, an embodiment will be described with reference to FIG. 2 in which the operating mode is changed in order to reduce power consumption of a mobile electronic device.

FIG. 2 is a flow chart illustrating a method of controlling a mobile electronic device according to an embodiment of the present invention.

According to the embodiment, the mobile electronic device 100 may acquire power saving condition (S210).

The power saving condition is used to determine whether the mobile electronic device 100 is operated in a power saving mode or in a non-power saving mode.

For example, the power saving condition may be a value that sets an orientation when the mobile electronic device is to be operated in the power saving mode. Further, the power saving condition may contain gradient information with respect to axes.

In the embodiment, the sensing unit 140 may acquire state information of the mobile electronic device (S220).

The state information indicates the orientation of the mobile electronic device in a spatial area.

For example, the mobile electronic device may collectively refer to directional information and gradient information.

In the embodiment, the controller 180 may determine the operating mode based on the state information and the power saving condition (S230).

The operating mode may include a power saving mode and a non-power saving mode.

The non-power saving mode may refer to a normal operating state of the mobile electronic device 100.

In addition, the power saving mode may refer to a state in which some of the functions of the mobile electronic device 100 are deactivated.

In the embodiment, the controller 180 may change the operating mode of the mobile electronic device based on the determined operating mode (S240).

Hereinafter, specific embodiments of the operations S210, S220, S230 and S240 shown in FIG. 2 will be described with reference to FIG. 2.

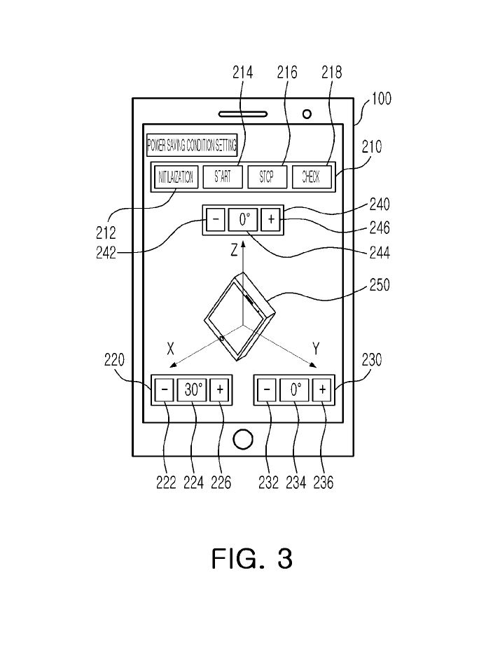

FIG. 3 is a diagram showing operation S210 shown in FIG. 2 according to an embodiment.

According to the embodiment, the display unit 151 may display a screen for receiving a power saving condition.

For example, the display unit 151 may display a menu area 210 for setting a power saving condition.

The menu area 210 may include an initialization area 212 for receiving initialization condition already stored.

The menu area 210 may include a start area 214, a stop area 216 and a check area 218 for receiving the range of the power saving condition.

The display unit 151 may represent the orientation of the mobile electronic device in a spatial area. For example, as shown in FIG. 3, the spatial area is represented by three-dimensional vector (an x-axis, a y-axis and a z-axis), in which the gradient of the mobile electronic device with respect to each of the axes (the x-axis, the y-axis and the z-axis) may be indicated.

Here, the display unit 151 may display the gradient of the mobile electronic device with respect to each of the axes as an image 250.

In the embodiment, the spatial area is represented using three axes (the x-axis, the y-axis and the z-axis). In addition, the gradient of the mobile electronic device with respect to the three axes (the x-axis, the y-axis and the z-axis) is represented by the state information.

If necessary, the spatial area may be represented by one or two axes. In these cases, the state information indicates the gradient of the mobile electronic device with respect to the one or two axes.

Alternatively, the spatial area may be represented by four or more axes.

According the embodiment, the display unit 150 may display predetermined axes (x-axis, y-axis and z-axis) representing a spatial area.

Here, the display unit 150 may display power-saving-condition input area 220, 230 and 240 for inputting a power saving condition with respect to the axes (the x-axis, the y-axis and the z-axis), respectively.

The first power-saving-condition input area 220 is to receive a power saving condition with respect to the x-axis. The first power-saving-condition input area 220 may include a first power-saving-condition displaying area 224 to display a set a power saving condition and first power-saving-condition changing areas 222 and 226 to change the power saving condition. Here, the power saving condition may be changed based on a user's input to the first power-saving-condition changing areas 222 and 226. For example, if a user's input to the first power-saving-condition changing area 222 is sensed, the power saving condition may be reduced by a predetermined degree of angle. Further, if a user's input to the first power-saving-condition changing area 226 is sensed, the power saving condition may be increased by a predetermined degree of angle. In addition, the angle of the x-axis for the power saving condition may also be changed by a user's at least one touch to the display unit 151.

The second power-saving-condition input area 230 is to receive a power saving condition with respect to the y-axis. The second power-saving-condition input area 230 may include a second power-saving-condition displaying area 234 to display a set power saving condition and second power-saving-condition changing areas 232 and 236 to change the power saving condition. Here, the power saving condition may be changed based on a user's input to the second power-saving-condition changing areas 232 and 236. For example, if a user's input to the second power-saving-condition changing area 232 is sensed, the power saving condition may be reduced by a predetermined degree of angle. Further, if a user's input to the second power-saving-condition changing area 236 is sensed, the power saving condition may be increased by a predetermined degree of angle. In addition, the angle of the y-axis for the power saving condition may also be changed by a user's at least one touch to the display unit 151.

The third power-saving-condition input area 240 is to receive a power saving condition with respect to the z-axis. The third power-saving-condition input area 240 may include a third power-saving-condition displaying area 244 to display a set power saving condition and a third power-saving-condition changing areas 242 and 246 to change the power saving condition. Here, the power saving condition may be changed based on a user's input to the third power-saving-condition changing areas 242 and 246. For example, if a user's input to the third power-saving-condition changing area 242 is sensed, the power saving condition may be reduced by a predetermined degree of angle. Further, if a user's input to the third power-saving-condition changing area 246 is sensed, the power saving condition may be increased by a predetermined degree of angle. In addition, the angle of the z-axis for the power saving condition may also be changed by a user's at least one touch to the display unit 151.

According to the embodiment, the user input unit 130 may acquire the power saving condition based on user inputs to the power-saving-condition input areas 220, 230 and 240.

Further, the state information acquired by the sensing unit 140 of the mobile electronic device 100 may be set as the initial state of the power saving condition. For example, when the mobile electronic device 100 enters a power-saving-condition setting mode, the sensing unit 140 may recognize the state information of the mobile electronic device 100 and the display unit 151 may display the state information as the initial value for setting the power saving condition.

Instead of setting the power saving condition based on the input via the user input unit, the state information acquired by the sensing unit 140 of the mobile electronic device 100 may be set as the power saving condition. For example, when the mobile electronic device 100 enters a power-saving-condition setting mode, the sensing unit 140 may recognize the state information of the mobile electronic device 100 and the use input unit 130 may acquire the state information as the power saving condition. If the state information is changed in the power-saving-condition setting mode, the power saving condition may also be changed according to the state information.

It is also possible that the mobile electronic device 100 acquires the power saving condition by a separate user input unit 130.

The power saving condition may be stored in the memory 160.

Referring to FIG. 3, the power saving condition is set such that it is met if the mobile electronic device is inclined by 30° with respect to the x-axis, and inclined by 0° with respect to the y-axis and the z-axis.

If specific values are set as the power saving condition, the controller 180 may recognize the specific values as the power saving condition.

Alternatively, the controller 180 may recognize a value within a predetermined range from the value set as the power saving condition, as the power saving condition. For example, the controller 180 may recognize a value within +10° and −10° range from the value set as the power saving condition, as the power saving condition.

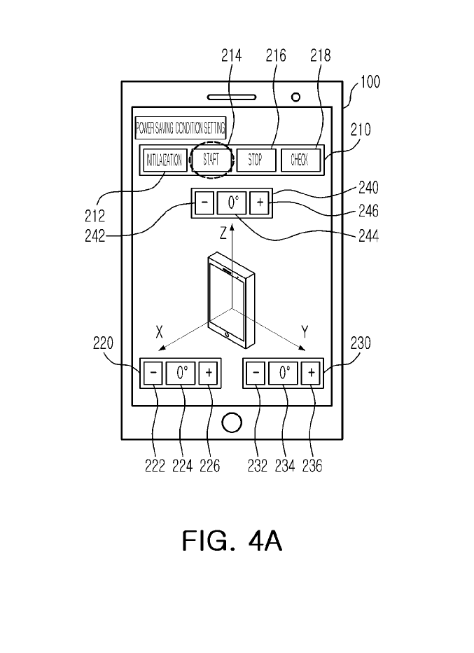

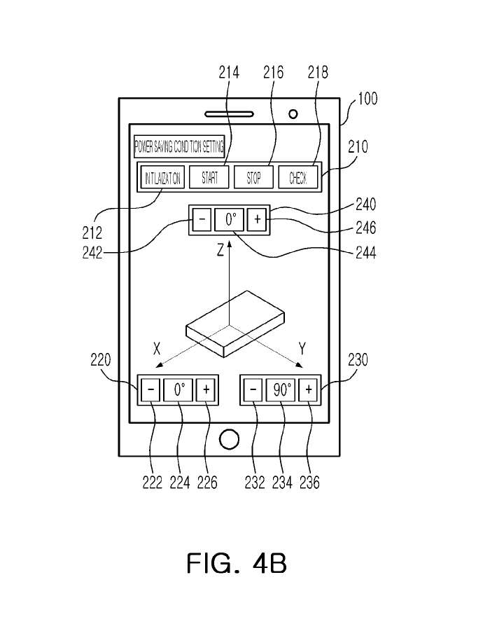

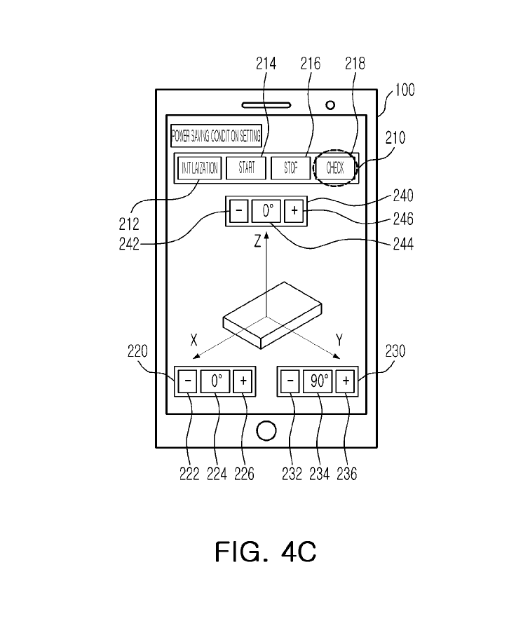

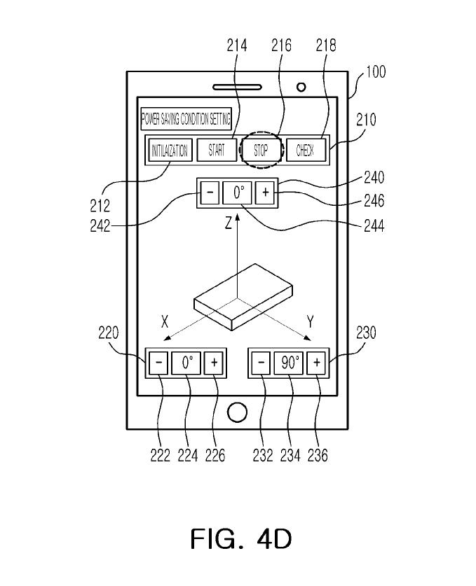

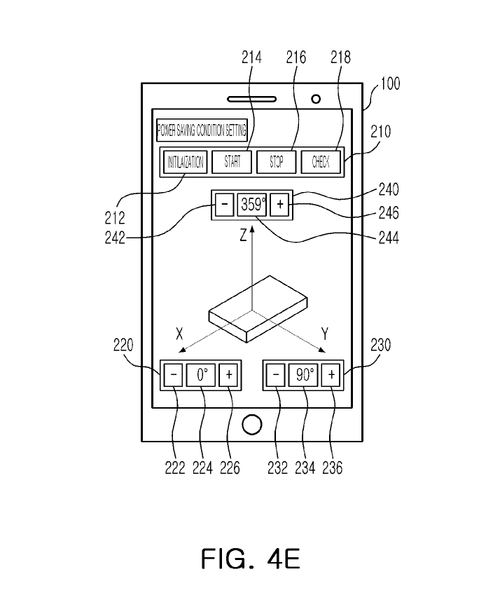

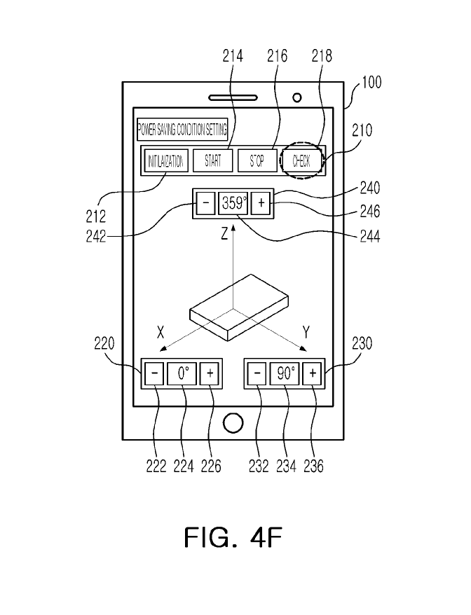

FIG. 4A to 4F are a diagram showing the operation S210 shown in FIG. 2 according to another embodiments.

According to this embodiment, the display unit 151 may display a menu area 210.

The menu area 210 may include a start area 214, a stop area 216 and a check area 218 for receiving the range of the power saving condition.

The mobile electronic device 100 may display a screen for receiving a start value for the power saving condition based on a user's input to the start area 214 (see FIG. 4A).

As described above, a power saving condition start value may be set based on a user's inputs to the power saving condition input areas 220, 230 and 240. Alternatively, the start value for the power saving condition may be set based on the state information acquired by the sensing unit 140 (see FIG. 4B).

The mobile electronic device 100 may determine the start value for the power saving condition based on a user's input to the check area 218 (see FIG. 4C).

Referring to FIG. 4C, the start value for the power saving condition is set such that it is met if the mobile electronic device 100 is inclined by 0° with respect to the x-axis, inclined by 0° with respect to the z-axis, and inclined by 90° with respect to the y-axis. Here, the set value may be determined as the start value for the power saving condition based on a user's input to the check area 218.

After the start value for the power saving condition is determined, the mobile electronic device 100 may display a screen for receiving the end value for the power saving condition based on a user's input to the stop area 216 (see FIG. 4D).

As described above, a power saving condition end value may be set based on a user's inputs to the power saving condition input areas 220, 230 and 240. Alternatively, the end value for the power saving condition may be set based on the state information acquired by the sensing unit 140 (see FIG. 4E).

The mobile electronic device 100 may determine the end value for the power saving condition based on a user's input to the check area 218 (see FIG. 4F).

Referring to FIG. 4F, the end value for the power saving condition is set such that it is met if the mobile electronic device 100 is inclined by 0° with respect to the x-axis, inclined by 359° with respect to the z-axis, and inclined by 90° with respect to the y-axis. Here, the set value may be determined as the end value for the power saving condition based on a user's input to the check area 218.

According to an embodiment of the present invention, a value between the start value and the end value for the power saving condition may be set as the range for the power saving condition.

For example, referring to FIG. 4A to 4F, the power saving condition may be the range that the mobile electronic device 100 is inclined 0° with respect to the x-axis, inclined by 0° to 359° with respect to the z-axis, and inclined by 90° with respect to the y-axis.

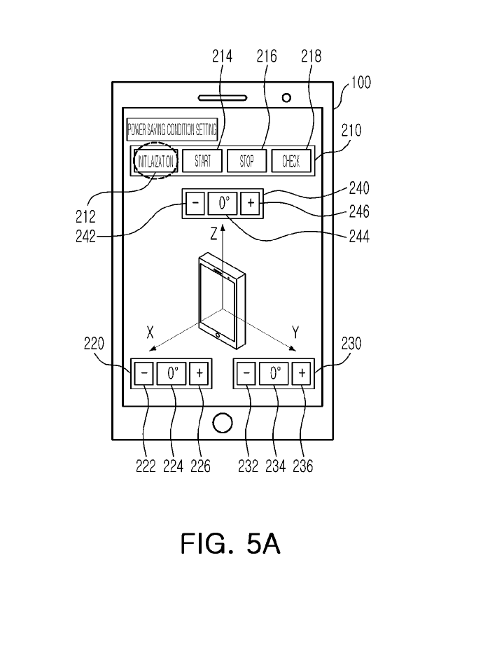

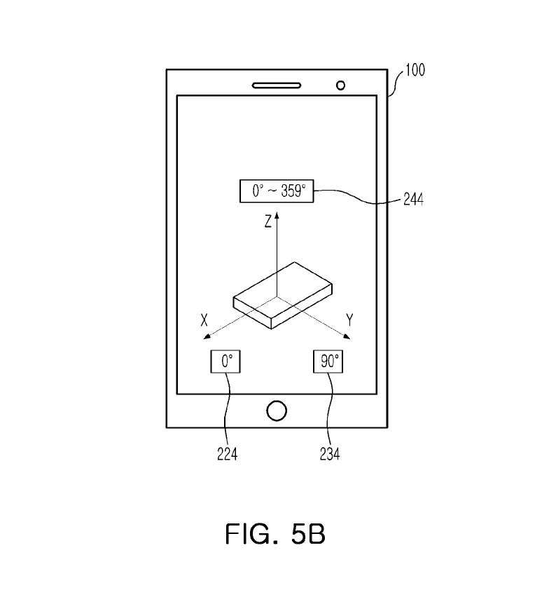

FIGS. 5A and 5B are a diagram showing operation S210 shown in FIG. 2 according to another embodiments.

According to this embodiment, the display unit 151 may display a menu area 210.

The menu area 210 may include an initialization area 212 for receiving initialization condition already stored.

If a user selects the initialization area 212, the mobile electronic device 100 may determine the information stored in the memory associated with the power saving condition as the power saving condition (see FIG. 5A).

In this case, the display unit 151 may display the power saving condition already stored. For example, if a user selects the initialization area 212, the display unit may display the gradient information already stored in the memory with respect to the predetermined three axes (the x-axis, the y-axis and the z-axis). Accordingly, the user may check the power saving condition through the screen displayed on the display unit 151.

For example, referring to FIG. 5B, the power saving condition already stored may be the range that the mobile electronic device 100 is inclined by 0° with respect to the x-axis, inclined by 0° to 359° with respect to the z-axis, and inclined by 90° with respect to the y-axis.

In the embodiment, the sensing unit 140 may acquire state information of the mobile electronic device (S220).

The state information indicates the orientation of the mobile electronic device in a spatial area.

For example, the mobile electronic device may collectively refer to directional information and gradient information.

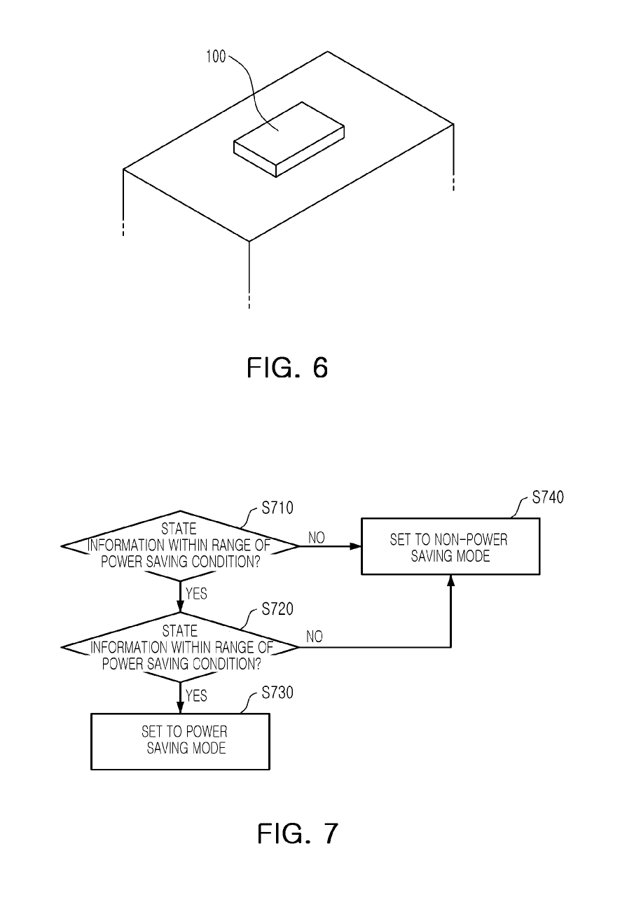

FIG. 6 is a diagram showing operation S220 shown in FIG. 2 according to an embodiment.

As shown in FIG. 6, when the mobile electronic device is oriented in a certain manner, the sensing unit 140 may acquire the state information of the mobile electronic device.

The state information may include the directional information and gradient information.

The directional information may represent a direction in which the front surface of the mobile electronic device 100 is facing. The gradient information may represent the gradient of the mobile electronic device 100 with respect to an axis.

Further, the axes used for the gradient information may be determined based on the directive information.

The sensing unit 140 may sense the directional information of the mobile electronics device 100, the gradient information of the mobile electronic device 100 and the like so as to generate a sensing signal for controlling the operation of the mobile electronic device 100.

The sensing unit 140 may acquire the state information of the mobile electronic device 100 if the mobile electronic device 100 remains stationary in a predetermined time period. This is because that it may be desired for the mobile electronic device 100 to be changed into the power saving mode if the mobile electronic device 100 remains at the same state beyond a predetermined time period. Further, without such a condition, the battery power may be further wasted since the operating mode of the mobile electronic device is repeatedly changed.

In the embodiment, the controller 180 may determine the operating mode based on the state information and the power saving condition (S230).

FIG. 7 is a diagram showing operation S230 shown in FIG. 2 according to an embodiment.

In the embodiment, the controller 180 may compare the state information of the mobile electronic device with the power saving condition to see if state information is within the range of the power saving condition (S710 and S720).

The comparing of the state information and the power saving condition may be repeated several times. This is because that the comparison result may be more accurately determined by increasing the number of comparison of the state information with the power saving condition.

If the state information falls within the power saving condition, the controller 180 may set the operating mode of the mobile electronic device 100 to the power saving mode (S730).

Further, if the state information does not fall within the power saving condition, the controller 180 may set the operating mode of the mobile electronic device 100 to the non-power saving mode (S740).

Even after the operating mode of the mobile electronic device 100 is set to the power saving mode or the non-power saving mode, the controller 180 may set the operating mode again based on the state information and the power saving condition.

In the embodiment, the controller 180 may change the operating mode of the mobile electronic device based on the determined operating mode (S240).

In the non-power saving mode, the mobile electronic device 100 may perform a normal operation.

In contrast, in the power saving mode, the mobile electronic device 100 may deactivate some of the functions. For example, in the power saving mode, at least one of the wireless communication unit 110, the A/V input unit 120, the user input unit 130, the sensing unit 140, the output unit 150, the memory 160, the interface unit 170, the controller 180 and the power supplying unit 190 may be deactivated. Alternatively, in the power saving mode, at least one of the modules included in each of the wireless communication unit 110, the A/V input unit 120, the user input unit 130, the sensing unit 140, the output unit 150, the memory 160, the interface unit 170, the controller 180 and the power supplying unit 190 may be deactivated.

In this connection, a state in which some function units or some modules are deactivated refers to the state in which the supply of power is completely interrupted, only some of the functions are performed, and the operation speed of a function is lowered.

For example, in the power saving mode, the controller 180 may interrupt the supply of power to some electronic components. Alternatively, in the power saving mode, the controller 180 may lower the operation speed or response speed of some electronic components. In the power saving mode, it may be appropriately determined depending on a user's necessity whether the supply of power to electronic component is completely interrupted or whether the operation speed of electronic components is lowered.

That is, in the power saving mode, the controller 180 may control the power consumption of some electronic components in order to reduce power consumption.

Accordingly, the battery power of the mobile electronic device may be saved by deactivating the display unit, the user input unit and the like depending on the orientation of the mobile electronic device. That is, the mobile electronic device may efficiently manage the battery by recognizing unnecessary functions based on the power saving condition and the state information.

The above-described methods according to the embodiments may be used separately from or in combination with one another. Further, operations in each of the embodiments may be used separately from or in combination with operations in other embodiments.

Further, the above-described methods may be implemented, for example, in a recording medium that is readable by a computer or a similar device by using software, hardware or a combination thereof.

With hardware implementation, exemplary embodiments described above may be implemented using at least one of application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, and electrical units for performing functions.

With software implementation, the procedures and functions described herein may be implemented as a separate software module. The software module may be implemented with software code written in an appropriate programming language. The software code may be stored in a storage unit and may be executed by a processor.

As set forth above, according to embodiments of the present invention, a power saving condition can be acquired by a simple and easy method.

Further, according to embodiments of the present invention, unnecessary power consumption can be minimized.

While the present invention has been shown and described in connection with the embodiments, it will be apparent to those skilled in the art that modifications and variations can be made without departing from the spirit and scope of the invention as defined by the appended claims.

What is claimed is:

1. A mobile electronic device comprising:
a user input unit receiving a power saving condition;
a sensing unit acquiring state information; and
a controller changing an operating mode based on the power saving condition and the state information.

2. The device of claim 1, wherein the power saving condition includes gradient information with respect to an axis.

3. The device of claim 1, further comprising a memory to store the power saving condition therein.

4. The device of claim 1, wherein the state information includes at least one of directional information and gradient information.

5. The device of claim 1, wherein the controller determines whether the state information falls within the range of the power saving condition, and, if so, sets an operating mode to a power saving mode.

6. The device of claim 1, wherein the controller determines whether the state information falls within the range of the power saving condition, and, if not, sets an operating mode to a non-power saving mode.

7. The device of claim 1, wherein the controller determines whether the state information falls within the range of the power saving condition several times.

8. A method of controlling a mobile electronic device, the method comprising:
acquiring a power saving condition;
acquiring state information; and
changing an operating mode based on the power saving condition and the state information.

9. The method of claim 8, wherein the acquiring of the power saving condition includes acquiring gradient information with respect to an axis.

10. The method of claim 8, wherein the acquiring of the power saving condition includes changing gradient information with respect to an axis.

11. The method of claim 8, wherein the acquiring of the power saving condition includes acquiring the power saving condition stored in a memory based on a user's input.

12. The method of claim 8, wherein the acquiring of the state information includes at least one of directional information and gradient information.

13. The method of claim 8, wherein the changing of the operating mode includes:
determining whether the state information falls within the range of the power saving condition; and
if so, setting an operating mode to a power saving mode.

14. The method of claim 8, wherein the changing of the operating mode includes:
determining whether the state information falls within the range of the power saving condition; and
if not, setting an operating mode to a non-power saving mode.

15. The method of claim 8, wherein the changing of the operating mode includes determining whether the state information falls within the range of the power saving conditions several times.
